(19) United States
(12) Patent Application Publication
(10) Pub. No.: US 2026/0112966 A1
(43) Pub. Date: Apr. 23, 2026

(54) Control Method for an Asymmetric Half-Bridge Circuit, Control Chip, Power Supply Circuit, and Charger

(71) Applicant: Dongguan Aohai Technology Co., Ltd., Dongguan (CN)

(72) Inventors: Kehua Ma, Dongguan (CN); Weiyue Zhao, Dongguan (CN); Bin Liu, Dongguan (CN); Hao Liu, Dongguan (CN); Daofei Xu, Dongguan (CN); Xiugen Guo, Dongguan (CN)

(21) Appl. No.: 19/361,058

(22) Filed: Oct. 17, 2025

(30) Foreign Application Priority Data
Oct. 17, 2024 (CN) 202411454548.3

(51) Int. Cl. H02M 1/38; H02M 1/00; H02M 1/08; H02M 1/42; H02M 1/44; H02M 3/335

(52) U.S. Cl. CPC H02M 1/385; H02M 1/0009; H02M 1/083; H02M 1/4233; H02M 1/44; H02M 3/33571

(57) ABSTRACT

The present application discloses a control method for an asymmetric half-bridge circuit, a control chip, a power supply circuit, and a charger. The control method includes: acquiring first detection data of the asymmetric half-bridge circuit; when the first detection data satisfies a preset light-load condition, turning off the first switching transistor and acquiring a current output voltage and a current turn-off current of the first switching transistor; acquiring a current conduction time of the second switching transistor based on the current output voltage and the current turn-off current of the first switching transistor. The control method makes the second switching transistor's conduction time inversely proportional to the output voltage, stabilizing the magnetizing inductance demagnetization time and keeping the transformer's negative current within a preset range.

### CROSS REFERENCE TO RELATED APPLICATIONS

The present application claims the benefit of Chinese Patent Application No. 202411454548.3 filed on Oct. 17, 2024, the contents of which are incorporated herein by reference in their entirety.

### TECHNICAL FIELD

The present application relates to the technical field of asymmetric half-bridge circuits, and more particularly to a control method for an asymmetric half-bridge circuit, a control chip, a power supply circuit, and a charger.

### BACKGROUND

With the continuous development of fast-charging technology, the charging power of fast chargers has been steadily increasing. Existing high-power fast chargers can expand the maximum output voltage to 48 V and the output current to 5 A, achieving a power of 240 W. Such power supplies typically adopt an asymmetric half-bridge topology to improve circuit efficiency and provide good EMC characteristics.

When controlling an asymmetric half-bridge circuit, different operating modes can be employed depending on the load conditions. For example, under light-load conditions, the asymmetric half-bridge circuit typically operates in discontinuous conduction mode (DCM) to improve the circuit's efficiency.

Currently, when controlling an asymmetric half-bridge circuit in DCM, the linear interpolation method is commonly used to calculate the conduction time of the low-side switch. However, under light-load conditions, the actual positive current through the high-side switch is smaller than that under full load. Moreover, in fast-charging power supply designs, the output voltage is variable. When the output voltage changes, the demagnetization time of the transformer's magnetizing inductance also changes. The low-side switch conduction time calculated using the linear interpolation method is based on the full-load demagnetization curve, which can result in excessively long demagnetization times and excessively large negative currents.

### SUMMARY

Embodiments of the present application provide a control method for an asymmetric half-bridge circuit, a control chip, an asymmetric half-bridge circuit, a power supply circuit, and a charger, aiming to address the problem in the prior art that the asymmetric half-bridge circuit generates an excessively large negative current under a light-load condition, resulting in poor operating efficiency.

An embodiment of the present application provides a control method for an asymmetric half-bridge circuit. The asymmetric half-bridge circuit includes a transformer, a first switching transistor, a second switching transistor, a resonant inductor, and a resonant capacitor; the first switching transistor has a first end configured to be connected to a bridge rectifier and a PFC circuit, a second end configured to be connected to a control chip, and a third end connected to a first end of the second switching transistor; the second switching transistor has a second end configured to be connected to the control chip, and a third end connected to ground; the resonant inductor, the resonant capacitor, and a primary winding of the transformer are connected in series between the third end of the first switching transistor and the third end of the second switching transistor; wherein the control method includes:
acquiring first detection data of the asymmetric half-bridge circuit;
when the first detection data satisfies a preset light-load condition, turning off the first switching transistor and acquiring a current output voltage and a current turn-off current of the first switching transistor;
acquiring a current conduction time of the second switching transistor based on the current output voltage and the current turn-off current of the first switching transistor, wherein the current conduction time is proportional to the current turn-off current and inversely proportional to the current output voltage; and
controlling the second switching transistor to conduct during the current conduction time, so that when the second switching transistor turns off, the current turn-off current of the second switching transistor is within a preset range.

Preferably, the first detection data includes a current output current; and
the preset light-load condition is that the current output current is less than a preset current.

Preferably, acquiring a current conduction time of the second switching transistor based on the current output voltage and the current turn-off current of the first switching transistor includes:
acquiring a rated turn-off current of the first switching transistor and a rated conduction time of the second switching transistor at rated maximum power; and
acquiring the current conduction time of the second switching transistor based on the rated turn-off current of the first switching transistor, the rated conduction time of the second switching transistor, the current output voltage, and the current turn-off current of the first switching transistor.

Preferably, acquiring a rated turn-off current of the first switching transistor at rated maximum power includes:
acquiring a target turn-off current at rated maximum power based on the output current at the rated maximum power and a transformer ratio of the asymmetric half-bridge circuit, wherein the target turn-off current is the sum of the rated turn-off current of the second switching transistor and the rated turn-off current of the first switching transistor; and
acquiring the rated turn-off current of the first switching transistor at the rated maximum power based on the rated turn-off current of the second switching transistor and the target turn-off current.

Preferably, acquiring a rated conduction time of the second switching transistor at rated maximum power includes:
acquiring, based on an output voltage at the rated maximum power and a transformation ratio of the asymmetric half-bridge circuit, a resonant capacitor voltage stored in the resonant capacitor when current continues flowing through a body diode of the second switching transistor after the first switching transistor is turned off;
acquiring, based on the rated turn-off current of the first switching transistor and a preset rated turn-off current of the second switching transistor, a current variation at the rated maximum power; and
acquiring, based on an inductance of the transformer of the asymmetric half-bridge circuit, the current variation at the rated maximum power, and the resonant capacitor voltage, the rated conduction time of the second switching transistor at the rated maximum power.

Preferably, acquiring the current conduction time of the second switching transistor based on the rated turn-off current of the first switching transistor, the rated conduction time of the second switching transistor, the current output voltage, and the current turn-off current of the first switching transistor includes:
substituting the rated turn-off current of the first switching transistor, the rated conduction time of the second switching transistor, the current output voltage, and the current turn-off current of the first switching transistor into formula

$$toff\_DCM = \frac{K * toff\_nom * Vnom * I\_Mag \_pos \_DCM}{Vout\_DCM * I\_Mag \_pos \_nom}$$

to obtain the current conduction time of the second switching transistor, wherein K is a correction coefficient, toff_nom is the rated conduction time of the second switching transistor, Vnom is the output voltage of the asymmetric half-bridge circuit at the maximum power level, I_Mag_pos_DCM is the current turn-off current of the first switching transistor, Vout_DCM is the current output voltage, and I_Mag_pos_nom is the rated turn-off current of the first switching transistor.

Preferably, when the current turn-off current of the first switching transistor is within a first preset range, the correction coefficient K takes a first correction value; and
when the current turn-off current of the first switching transistor is within a second preset range, the correction coefficient K takes a second correction value.

An embodiment of the present application further provides a control chip, including a memory, a processor, and a computer program stored in the memory and executable on the processor, wherein the control chip is applied in an asymmetric half-bridge circuit, and when the processor executes the computer program, the control method for an asymmetric half-bridge circuit described above is implemented.

An embodiment of the present application further provides a power supply circuit, including a bridge rectifier with PFC circuit, an electrolytic capacitor, an asymmetric half-bridge circuit, a secondary rectifier-filter circuit, a protocol control module, and the control chip described above; wherein
an input terminal of the bridge rectifier with PFC circuit is configured to be connected to a mains circuit, and an output terminal of the bridge rectifier with PFC circuit is connected to the electrolytic capacitor;
an input terminal of the asymmetric half-bridge circuit is connected to the electrolytic capacitor, and an output terminal of the asymmetric half-bridge circuit is connected to an input terminal of the secondary rectifier-filter circuit;
an output terminal of the secondary rectifier-filter circuit is configured to be connected to an external load to supply power to the external load;
the control chip is connected to the first switching transistor and the second switching transistor in the asymmetric half-bridge circuit; and the control chip is configured to, when the first detection data of the asymmetric half-bridge circuit satisfies the preset light-load condition, control the second switching transistor to conduct during the current conduction time, so that the current turn-off current of the second switching transistor is within the preset range;
the protocol control module is connected to the output terminal of the secondary rectifier-filter circuit, the asymmetric half-bridge circuit, and the control chip; and the protocol control module is configured to, based on a power demand of the external load, output a voltage adjustment signal to the control chip, so that the control chip adjusts the magnitude of a supply voltage output by the asymmetric half-bridge circuit according to the voltage adjustment signal.

An embodiment of the present application further provides a charger, including the power supply circuit described above.

In the control method for an asymmetric half-bridge circuit, the control chip, the power supply circuit, and the charger provided in embodiments of the present application, the current conduction time of the second switching transistor is inversely proportional to the current output voltage and directly proportional to the current turn-off current of the first switching transistor. This can overcome variations in demagnetization time of the magnetizing inductance caused by changes in the output voltage of the asymmetric half-bridge circuit, and ensure that the negative current after transformer demagnetization remains within a preset range, thereby meeting the requirements for the first switching transistor when the asymmetric half-bridge circuit operates in DCM mode.

### BRIEF DESCRIPTION OF THE DRAWINGS

To clearly illustrate the technical solutions of the embodiments of this application, the following briefly introduces the accompanying drawings used in the description of the embodiments. It should be apparent that, the drawings in the following description are only some embodiments of this application. For those skilled in the art, other drawings can be obtained based on these drawings without creative effort.

FIG. 1 is a schematic circuit diagram of an asymmetric half-bridge circuit in an embodiment of the present application.

FIG. 2 is a waveform diagram of the asymmetric half-bridge circuit in an embodiment of the present application.

FIG. 3 is another waveform diagram of the asymmetric half-bridge circuit in an embodiment of the present application.

FIG. 4 is a flowchart of a control method for an asymmetric half-bridge circuit in an embodiment of the present application.

FIG. 5 is another flowchart of the control method for an asymmetric half-bridge circuit in an embodiment of the present application.

FIG. 6 is yet another flowchart of the control method for an asymmetric half-bridge circuit in an embodiment of the present application.

FIG. 7 is still another flowchart of the control method for an asymmetric half-bridge circuit in an embodiment of the present application.

### DETAILED DESCRIPTION OF PREFERRED EMBODIMENTS

The technical solutions in the embodiments of the present application will be clearly and completely described below with reference to the drawings in the embodiments of this application. It should be apparent that, the described embodiments are merely part of the embodiments of this application, not all of them. Based on the embodiments in this application, all other embodiments obtained by those of ordinary skill in the art without creative effort belong to the protection scope of this application.

It should be understood that the exemplary embodiments may be embodied in many different forms and should not be construed as being limited to the exemplary embodiments set forth herein. Rather, these embodiments are provided so that this disclosure will be thorough and complete, and will fully convey the protection scope of this application to those skilled in the art. In the drawings, like reference signs refer to like elements throughout, and the size and relative sizes of layers and regions may be exaggerated for clarity.

It should be understood that when an element or layer is referred to as being “on”, “adjacent to”, “connected to”, “coupled to” another element or layer, it can be directly on, adjacent to, connected to, coupled to the other element or layer, or intervening elements or layers may be present. Conversely, when an element is referred to as being “directly on”, “directly adjacent to”, “directly connected to” or “directly coupled to” another element or layer, there are no intervening elements or layers present. It should also be understood that although terms such as “first”, “second”, “third” etc., may be used to describe various elements, components, regions, layers, and/or parts, these elements, components, regions, layers, and/or parts should not be limited by these terms. These terms are used only to distinguish one element, component, region, layer, or part from another. Thus, without departing from the teachings of this application, a first element, component, region, layer, or part discussed below could be termed a second element, component, region, layer, or part.

Spatial terms such as “below”, “under”, “down”, “above”, “on” and “up” may be used here for convenience of description to describe the relationship between one element or feature and other elements or features shown in the figures. It should be understood that in addition to the orientations shown in the figures, the spatial relationship terms are intended to include different orientations of devices in use and operation. For example, if the device in the figures is turned upside down, then the elements or features described as “below” or “under” other elements or features would be “above” or “on” other elements or features. Therefore, the exemplary terms “below” or “under” may include the orientations of “above” or “on”. The device may be otherwise oriented (rotated by 90 degrees or other orientations) and the spatial description terms used here are interpreted accordingly.

The terms used here are only for the purpose of describing specific embodiments and not as a limitation of the present application. As used herein, singular forms of “a”, “an” and “the/said” are also intended to include plural forms, unless the context clearly indicates otherwise. It should also be understood that the terms “comprise” and/or “include” used in this specification specify the presence of said features, integers, steps, operations, elements and/or components, but do not exclude the presence or addition of one or more other features, integers, steps, operations, elements, components and/or groups. As used herein, the term “and/or” includes any and all combinations of related listed items.

For a thorough understanding of this application, detailed structures and steps will be set forth in the following description, so as to illustrate the technical solution proposed in the present application. The preferred embodiments of the present application are described in detail as follows, but besides these detailed descriptions, the present application may also have other embodiments.

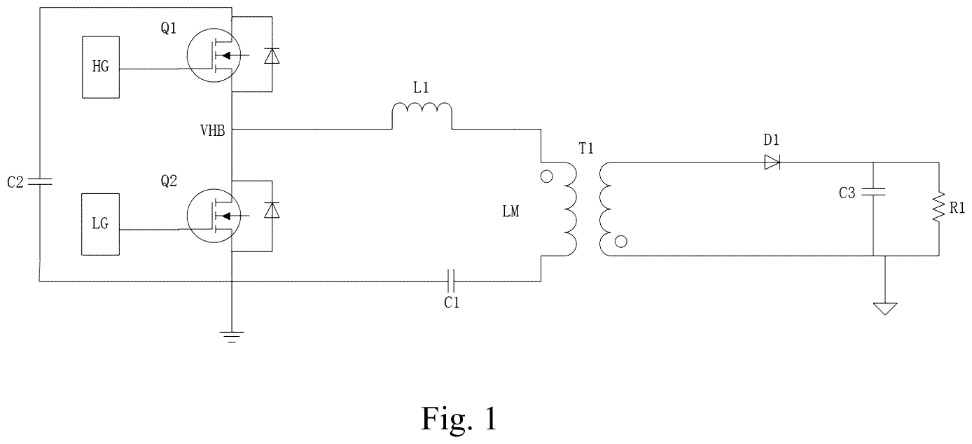

An embodiment of the present application provides a control method for an asymmetric half-bridge circuit. As shown in FIG. 1, the asymmetric half-bridge circuit includes a transformer T1, a first switching transistor Q1, a second switching transistor Q2, a resonant inductor L1, and a resonant capacitor C1; a first end of the first switching transistor Q1 is configured to be connected to a bridge rectifier with PFC circuit, a second end of the first switching transistor Q1 is configured to be connected to a control chip, and a third end of the first switching transistor Q1 is connected to a first end of the second switching transistor Q2; a second end of the second switching transistor Q2 is configured to be connected to the control chip, and a third end of the second switching transistor Q2 is connected to ground; the resonant inductor L1, the resonant capacitor C1, and a primary winding of the transformer T1 are connected in series between the third end of the first switching transistor Q1 and the third end of the second switching transistor Q2.

The asymmetric half-bridge circuit shown in FIG. 1 can operate in different modes under different load conditions. For example, under heavy-load conditions, it typically operates in Critical Conduction Mode (hereinafter referred to as CRM mode), whereas under light-load conditions, it typically operates in Discontinuous Conduction Mode (hereinafter referred to as DCM mode). A light-load condition refers to a situation where the load ratio of the asymmetric half-bridge circuit is low, the output current is small, and the output power is low, while a heavy-load condition refers to a situation where the load ratio of the asymmetric half-bridge circuit is high, the output current is large, and the output power is high.

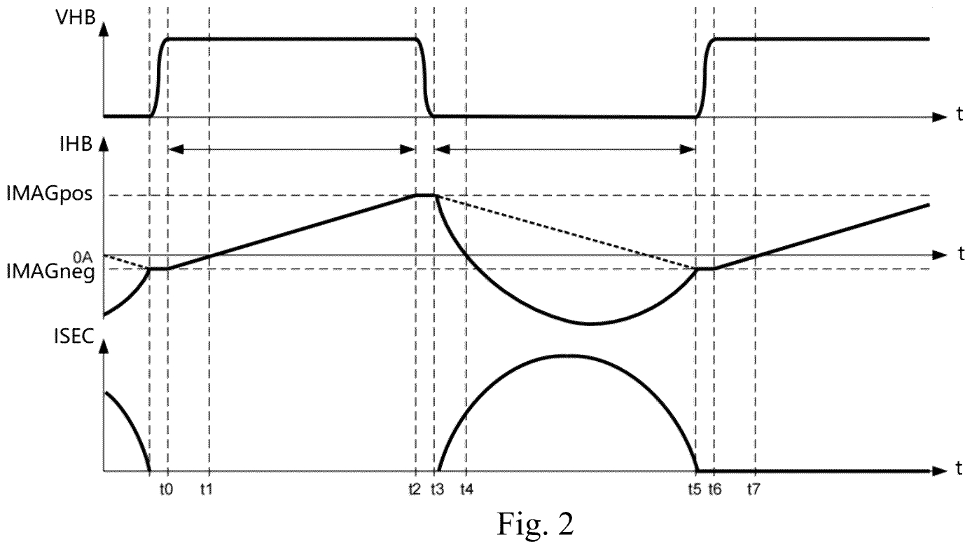

When the asymmetric half-bridge circuit operates in CRM mode, the operating waveform is shown in FIG. 2:
(1) Stage t0-t2. Before t0, the body diode of the first switching transistor Q1 gradually conducts, and the turn-off current of the second switching transistor Q2 causes the voltage at point VHB to gradually rise from 0 V to Vbus, providing conditions for zero-voltage switching (ZVS) of the first switching transistor Q1. At time t0, the control chip outputs a high level to the gate of the first switching transistor Q1, transferring the current from the body diode of the first switching transistor Q1 to its channel, where IMAGneg is the peak value of the negative current.

During the t1-t2 period, the resonant tank current sequentially flows through the resonant inductor L1, the magnetizing inductance LM of the primary winding of the transformer T1, and the resonant capacitor C2. The current rises linearly, storing energy in the resonant tank, where IMAGpos is the peak value of the positive operating current of the first switching transistor Q1.
(2) Stage t2-t5. At time t2, the control chip outputs a low level to the gate of the first switching transistor Q1, and I_Mag_pos continues flowing through the body diode of Q2, causing the voltage at point VHB to drop from Vbus to 0, providing conditions for ZVS of the second switching transistor Q2. At time t3, the control chip outputs a high level to the gate of the second switching transistor Q2, transferring the current from the body diode of the second switching transistor Q2 to its channel. During the t3-t5 period, the energy stored in the resonant tank is released to the secondary side. At this time, the output freewheeling diode DI connected to the secondary winding of the transformer T1 conducts. The voltage across the magnetizing inductance LM is clamped at NVout, where N represents the turns ratio of the primary winding to the secondary winding of transformer T1, and Vout represents the output voltage. Therefore, the magnetizing current decreases linearly with a slope of NVout/LM. Meanwhile, the resonant capacitor C1 and the resonant inductor L1 resonate, and the resonant current varies according to a sinusoidal pattern. When the resonant current equals the magnetizing current, the output freewheeling diode turns off, corresponding to time t5.

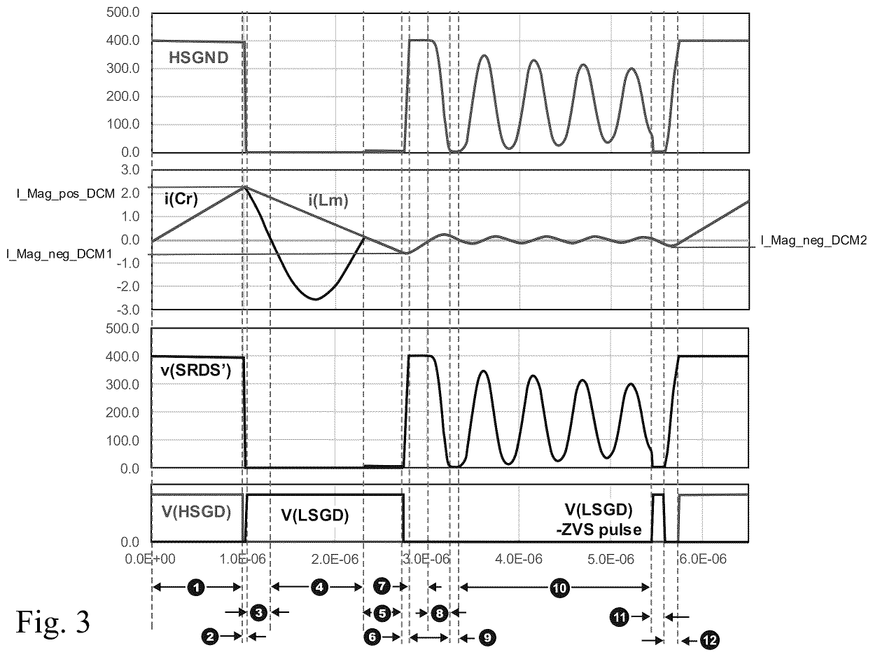

When the asymmetric half-bridge circuit operates in DCM mode, the operating waveform is shown in FIG. 3:
(1) Processes 1-5: same as stages t1-t5 in CRM operation.
(2) Process 6: the turn-off current of the second switching transistor Q2, i.e., the negative current I_Mag_neg_DCM1, causes the voltage at point VHB to rise to Vbus, enabling a soft turn-on of the first switching transistor Q1.
(3) Process 7: VHB is maintained at Vbus, and i(LM) transitions from I_Mag_neg_DCM1 to 0 V.
(4) Processes 8-10: free oscillation of VHB, during which, in process 9, the voltage at point VHB oscillates down to 0 V.
(5) Process 11: the second switching transistor Q2 conducts, generating a negative current I_Mag_neg_DCM2 in i(LM).
(6) Process 12: the negative current I_Mag_neg_DCM2 of the second switching transistor Q2 during free oscillation enables ZVS of the first switching transistor Q1.

In DCM mode, if the negative current I_Mag_neg_DCM1 is too large, it can cause the voltage at VHB in process 6 to rise too quickly, affecting EMC performance, prolong the maintenance time in process 7, and, in process 8, when VHB drops to zero, may cause false triggering of synchronous rectification. Therefore, it is necessary to ensure that the negative current I_Mag_neg_DCM1 remains within a preset reasonable range. Since I_Mag_neg_DCM1 is related to the conduction time of the low-side switch during processes 3-5 (i.e., t3-t5), it is necessary to control the conduction time of the low-side switch in t3-t5 so that the negative current I_Mag_neg_DCM1 stays within the preset range.

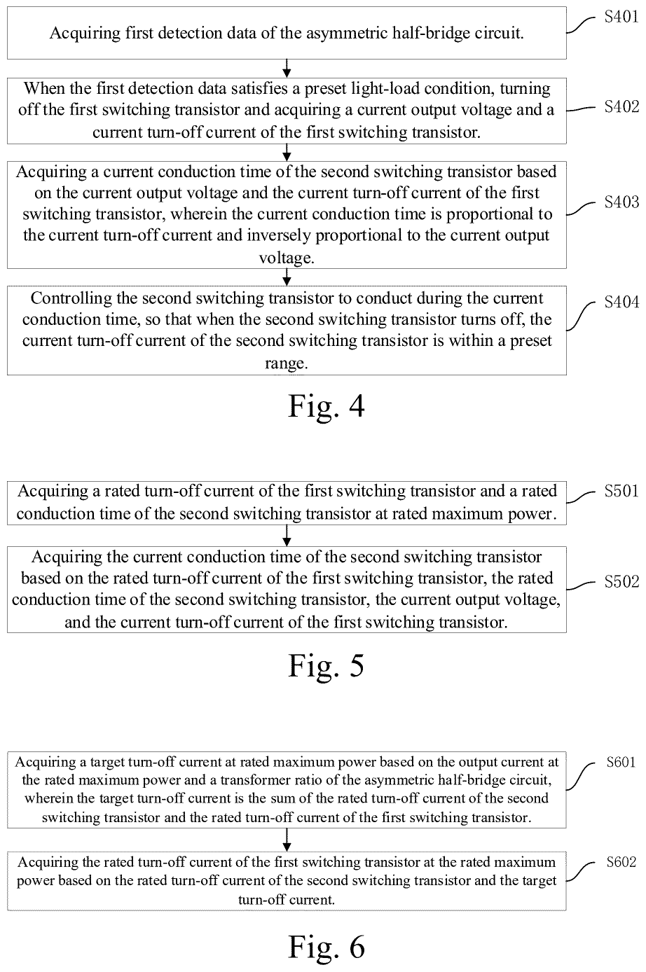

Taking the application of this method in the above asymmetric half-bridge circuit as an example, as shown in FIG. 4, the control method for an asymmetric half-bridge circuit includes:
S401: acquiring first detection data of the asymmetric half-bridge circuit;
S402: when the first detection data satisfies a preset light-load condition, turning off the first switching transistor and acquiring a current output voltage and a current turn-off current of the first switching transistor;
S403: acquiring a current conduction time of the second switching transistor based on the current output voltage and the current turn-off current of the first switching transistor, wherein the current conduction time is proportional to the current turn-off current and inversely proportional to the current output voltage;
S404: controlling the second switching transistor to conduct during the current conduction time, so that when the second switching transistor turns off, the current turn-off current of the second switching transistor is within a preset range.

The first detection data is detected in real time by the control chip and is used to determine whether the asymmetric half-bridge circuit is currently operating under light-load conditions. For example, the first detection data may be the current output current Iout_DCM. If the current output current Iout_DCM is less than a preset current, the control chip determines that the asymmetric half-bridge circuit is under light-load conditions.

As an example, in step S401, the control chip detects the first detection data, such as the current output current Iout_DCM, in real time and determines, based on the first detection data, whether the asymmetric half-bridge circuit is currently under light-load conditions, so that when the asymmetric half-bridge circuit is under light-load conditions, it operates in DCM mode.

Here, the current turn-off current I_Mag_pos_DCM of the first switching transistor Q1 is the peak value of the positive operating current of the first switching transistor Q1 in the asymmetric half-bridge circuit under light-load conditions after entering DCM mode, corresponding to process 2 in FIG. 3.

As an example, in step S402, if the control chip detects that the asymmetric half-bridge circuit is operating under light-load conditions, the circuit is controlled to enter DCM mode. The first switching transistor Q1 and the second switching transistor Q2 are controlled according to the DCM mode. After the first switching transistor Q1 turns off, the control chip acquires the current output voltage Vout_DCM of the asymmetric half-bridge circuit and the current turn-off current I_Mag_pos_DCM of the first switching transistor Q1.

Here, the current conduction time toff_DCM of the second switching transistor Q2 is the conduction time of Q2 when the asymmetric half-bridge circuit is under light-load conditions and operates in DCM mode, corresponding to processes 3-5 in FIG. 3.

As an example, in step S403, the control chip acquires the current conduction time toff_DCM of the second switching transistor Q2 based on the current output voltage Vout_DCM and the current turn-off current I_Mag_pos_DCM of the first switching transistor Q1. The current conduction time toff_DCM of the second switching transistor Q2 is inversely proportional to the current output voltage Vout_DCM and proportional to the current turn-off current I_Mag_pos_DCM of the first switching transistor Q1, so that the current conduction time toff_DCM of the second switching transistor Q2 decreases with increasing output voltage according to an inverse proportional function. This compensates for changes in demagnetization time caused by variations in output voltage and prevents excessively long demagnetization times or overly large negative currents.

Specifically, the above conclusion can be derived as follows.

According to the voltage regulation principle of the asymmetric half-bridge circuit, resonant capacitor voltage Vcr≈transformer magnetizing inductor voltage VLM. The transformer magnetizing inductor voltage is VLM=N*Vout, N is the ratio of transformer T1, Vout is the output voltage, and the resonant capacitor voltage is

$$Vcr = LM * \frac{dI}{d C} = L M * \frac{( I MAG pos - I M A G n e g )}{tLS\_on} .$$

Here, LM is the inductance of transformer T1, IMAGpos is the peak value of the positive operating current of the first switching transistor Q1, IMAGneg is the peak value of the negative current, and tLS_on is the conduction time of the second switching transistor Q2. Therefore, when the asymmetric half-bridge circuit operates at the maximum power level, the resonant capacitor voltage satisfies the following equation:

$$Vcr\_nom = N * Vnom = LM * \frac{( I\_Mag \_pos \_nom - I\_Mag \_neg \_nom )}{toff\_nom} , \qquad ( Equation 1 )$$

where Vnom is the output voltage at the maximum power level.

When the asymmetric half-bridge circuit operates under light-load conditions and enters DCM mode, the resonant capacitor voltage satisfies the following equation:

$$Vcr\_DCM = N * Vout\_DCM = L M * \frac{( I\_Mag \_pos \_DCM - I\_Mag \_neg \_DCM )}{toff\_DCM} , \qquad ( Equation 2 )$$

where Vout_DCM is the current output voltage of the asymmetric half-bridge circuit in DCM mode.

Based on the equality of the inductance LM of the asymmetric half-bridge circuit at maximum power level and in DCM mode, combining Equation 1 and Equation 2 gives:

$$\frac{toff\_DCM * Vout\_DCM}{( I\_Mag \_pos \_DCM - I\_Mag \_neg \_DCM )} = \frac{toff\_nom * Vnom}{( I\_Mag \_pos \_nom - I\_Mag \_neg \_nom )} , \qquad ( Equation 3 )$$

Therefore, according to the voltage regulation principle of the asymmetric half-bridge circuit, the conduction time toff_DCM of the second switching transistor is inversely proportional to the current output voltage Vout_DCM and proportional to the current turn-off current I_Mag_pos_DCM of the first switching transistor Q1. Accordingly, when setting the current conduction time toff_DCM of the second switching transistor Q2, it is configured to decrease with increasing current output voltage Vout_DCM according to an inverse proportional function. This approach better conforms to the voltage regulation principle of the asymmetric half-bridge circuit, compensates for demagnetization time variations caused by output voltage changes, and prevents excessive demagnetization time or negative current.

Here, the current turn-off current I_Mag_neg_DCM of the second switching transistor Q2 is the peak negative current of the asymmetric half-bridge circuit in DCM mode, as shown in process 5 of FIG. 3, which enables the first switching transistor Q1 to achieve ZVS when the asymmetric half-bridge circuit is operating in DCM mode.

As an example, in step S404, the control chip controls the conduction of the second switching transistor Q2 based on its current conduction time toff_DCM, so that the current turn-off current I_Mag_neg_DCM of the second switching transistor Q2, i.e., the negative current, remains within a preset range. This ensures that when the asymmetric half-bridge circuit operates in DCM mode, the first switching transistor Q1 can successfully achieve ZVS.

In this example, the control chip determines the current conduction time toff_DCM of the second switching transistor Q2 according to the current output voltage Vout_DCM and the current turn-off current I_Mag_pos_DCM of the first switching transistor Q1. The current conduction time toff_DCM of the second switching transistor Q2 is inversely proportional to the current output voltage Vout_DCM and proportional to the current turn-off current I_Mag_pos_DCM of the first switching transistor Q1. This configuration compensates for demagnetization time variations caused by changes in the output voltage, maintains the negative current after demagnetization of transformer T1 within a preset range, and ensures that the first switching transistor Q1 meets the ZVS requirement when the asymmetric half-bridge circuit operates in DCM mode.

In one embodiment, the first detection data includes the current output current Iout_DCM, and the preset light-load condition is that the current output current Iout_DCM is less than a preset current.

As an example, the first detection data includes the current output current Iout_DCM of the asymmetric half-bridge circuit detected by the control chip. When the current output current Iout_DCM is lower than the preset current, the control chip determines that the asymmetric half-bridge circuit is operating under light-load conditions and controls the circuit to operate in DCM mode. The preset current is a predefined current used to determine whether the asymmetric half-bridge circuit is under light-load conditions. The preset current may, for example, be 20% of the full-load current or another suitable value. For instance, when the full-load current is 5 A, the preset current is 1 A. When the current output current Iout_DCM is less than 1 A, it indicates that the asymmetric half-bridge circuit is in a light-load condition, and the control chip controls the circuit to operate in DCM mode.

In one embodiment, as shown in FIG. 5, in step S403, acquiring a current conduction time of the second switching transistor based on the current output voltage and the current turn-off current of the first switching transistor includes:
S501: acquiring a rated turn-off current of the first switching transistor and a rated conduction time of the second switching transistor at rated maximum power;
S502: acquiring the current conduction time of the second switching transistor based on the rated turn-off current of the first switching transistor, the rated conduction time of the second switching transistor, the current output voltage, and the current turn-off current of the first switching transistor.

Here, the rated turn-off current I_Mag_pos_nom of the first switching transistor Q1 is the peak positive operating current of Q1 at the rated maximum power, and the rated conduction time toff_nom of the second switching transistor Q2 is the conduction time of Q2 at the rated maximum power.

As an example, in step S501, the control chip obtains the rated turn-off current I_Mag_pos_nom of the first switching transistor Q1 and the rated conduction time toff_nom of the second switching transistor Q2 when the asymmetric half-bridge circuit operates at the rated maximum power, based on the original circuit parameters of the asymmetric half-bridge circuit, such as the ratio N of the transformer T1, and the maximum output voltage and maximum output current at the rated operating condition.

As an example, in step S502, the control chip determines the current conduction time toff_DCM of the second switching transistor Q2 according to the current output voltage Vout_DCM, the current turn-off current I_Mag_pos_DCM of the first switching transistor Q1, the rated conduction time toff_nom of the second switching transistor Q2, and the rated turn-off current I_Mag_pos_nom of the first switching transistor Q1. The current conduction time toff_DCM of the second switching transistor Q2 is inversely proportional to the current output voltage Vout_DCM and proportional to the current turn-off current I_Mag_pos_DCM of the first switching transistor Q1.

Specifically, according to the voltage regulation principle of the asymmetric half-bridge circuit, one obtains:

$$\frac{toff\_DCM * Vout\_DCM}{( I\_Mag \_pos \_DCM - I\_Mag \_neg \_DCM )} = \frac{toff\_nom * Vnom}{( I\_Mag \_pos \_nom - I\_Mag \_neg \_nom )} . \qquad ( Equation 3 )$$

During the operation of the asymmetric half-bridge circuit, the average current input to the asymmetric half-bridge circuit is

$$Iavg = \frac{1}{2} ( IMAGpos + IMAGneg ) * D ,$$

where IMAGpos represents the positive operating current peak value of the first switching transistor Q1, IMAGneg represents the negative current peak value. The input power is Pin=Vin*Iavg, and the output power is Pout=Vout*Iout. According to the principle of energy conservation between input and output: Pin≈Pout, and the relationship between the input voltage and the output voltage:

$$Vout = \frac{V i n * D}{N} ,$$

one obtains:

$$Iout = \frac{N}{2} ( IMAGpos + IMAGneg ) .$$

Therefore, based on the formula

$$Iout = \frac{N}{2} ( IMAGpos + IMAGneg ) ,$$

I_Mag_neg_DCMin Equation 3 can be expressed using Iout_DCM and IMag_pos_DCM. Eventually, I_Mag_pos_DCM−I_Mag_neg_DCM in Equation 3 is approximated by IMag_pos_DCM, and I_Mag_pos_nom−I_Mag_neg_nom in Equation 3 is approximated by IMag_pos_nom.

To eliminate the error introduced by the approximation, the approximated Equation (3) can be multiplied by a correction coefficient K to obtain:

$$\frac{toff\_DCM * Vout\_DCM}{I\_Mag \_pos \_DCM} = K * \frac{toff\_nom * Vnom}{I\_mag \_pos \_nom} ; \qquad ( Equation 4 )$$

$$Simplifying gives toff\_DCM = \frac{K * toff\_nom * Vnom * I\_Mag \_pos \_DCM}{Vout\_DCM * I\_Mag \_pos \_nom} ;$$

By substituting the current output voltage Vout_DCM, the current turn-off current IMag_pos_DCM of the first switching transistor Q1, the rated turn-on time toff_nom of the second switching transistor Q2, and the rated turn-off current IMag_pos_nom of the first switching transistor Q1 into Equation (4), the current turn-on time toff_DCM of the second switching transistor Q2 can be calculated.

In this example, the control chip determines the current turn-on time toff_DCM of the second switching transistor Q2 based on the current output voltage Vout_DCM, the current turn-off current IMag_pos_DCM of the first switching transistor Q1, the rated turn-on time toff_nom of the second switching transistor Q2, and the rated turn-off current IMag_pos_nom of the first switching transistor Q1. The current turn-on time toff_DCM of the second switching transistor Q2 is inversely proportional to the current output voltage Vout_DCM and directly proportional to the current turn-off current IMag_pos_DCM of the first switching transistor Q1. This configuration compensates for variations in the demagnetization time of the magnetizing inductor caused by changes in the output voltage of the asymmetric half-bridge circuit, ensuring that the negative current after the demagnetization of transformer T1 remains within a predetermined range and that the first switching transistor Q1 can achieve ZVS when the asymmetric half-bridge circuit operates in DCM mode.

In one embodiment, as shown in FIG. 6, in step S501, acquiring a rated turn-off current of the first switching transistor at rated maximum power includes:
S601: acquiring a target turn-off current at rated maximum power based on the output current at the rated maximum power and a transformer ratio of the asymmetric half-bridge circuit, wherein the target turn-off current is the sum of the rated turn-off current of the second switching transistor and the rated turn-off current of the first switching transistor;
S602: acquiring the rated turn-off current of the first switching transistor at the rated maximum power based on the rated turn-off current of the second switching transistor and the target turn-off current.

As an example, in step S601, during the operation of the asymmetric half-bridge (AHB) circuit, the average current input to the AHB is

$$Iavg = \frac{1}{2} ( IMAGpos + IMAGneg ) * D ,$$

where IMAGpos is the positive peak current of the first switching transistor Q1, and IMAGneg is the negative current peak, the input power is Pin=Vin*Iavgand output power is Pout=Vout*Iout. According to energy conservation between input and output: Pin≈Pout, and the relationship between input voltage and output voltage:

$$Vout = \frac{V i n * D}{N} ,$$

one obtains:

$$Iout = \frac{N}{2} ( IMAGpos + IMAGneg ) .$$

### Therefore, it is

$$I\_Mag \_neg \_nom + I\_Mag \_pos \_nom = \frac{2 Iout\_nom}{N} ,$$

where Iout_nom is the output current under the rated maximum power. The control chip, based on the output current Iout_nom at rated maximum power and the ratio N of the transformer T1 of the assymetric half-bridge circuit, according to the formula

$$I\_Mag \_neg \_nom + I\_Mag \_pos \_nom = \frac{2 Iout\_nom}{N} ,$$

can calculate the sum of the rated turn-off current I_Mag_neg_nom of the second switching transistor Q2 and the rated turn-off current I_Mag_pos_nom of the first switching transistor Q1, that is, the target turn-off current.

The rated turn-off current I_Mag_neg_nom of the second switching transistor Q2 is preset and is capable of ensuring that the first switching transistor Q1 achieves ZVS when the asymmetric half-bridge circuit operates at rated maximum power. This current is determined based on the ZVS requirement of the first switching transistor Q1, requiring that the product of the transformer T1 inductance LM and the preset rated turn-off current I_Mag_neg_nom of the second switching transistor Q2 be greater than twice the product of the electrolytic capacitor voltage Vbus and the parasitic capacitance of the first switching transistor Q1.

As an example, in step S602, at rated maximum power, based on the preset rated turn-off current I_Mag_neg_nom of the second switching transistor Q2 and the sum of the calculated I_Mag_neg_nom of the second switching transistor Q2 and the rated turn-off current I_Mag_pos_nom of the first switching transistor Q1, the rated turn-off current I_Mag_pos_nom of the first switching transistor Q1 under rated maximum power can be obtained.

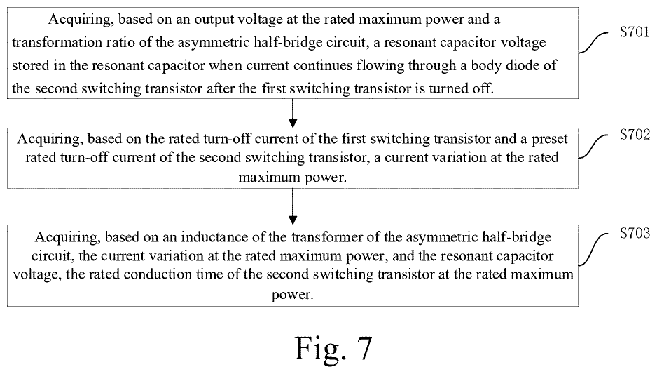

In one embodiment, as shown in FIG. 7, in step S501, acquiring a rated conduction time of the second switching transistor at rated maximum power includes:
S701: acquiring, based on an output voltage at the rated maximum power and a transformation ratio of the asymmetric half-bridge circuit, a resonant capacitor voltage stored in the resonant capacitor when current continues flowing through a body diode of the second switching transistor after the first switching transistor is turned off;
S702: acquiring, based on the rated turn-off current of the first switching transistor and a preset rated turn-off current of the second switching transistor, a current variation at the rated maximum power;
S703: acquiring, based on an inductance of the transformer of the asymmetric half-bridge circuit, the current variation at the rated maximum power, and the resonant capacitor voltage, the rated conduction time of the second switching transistor at the rated maximum power.

As an example, in step S701, according to the voltage regulation principle of the asymmetric half-bridge circuit, resonant capacitor voltage Vcr≈transformer magnetizing inductor voltage VLM, where transformer magnetizing inductor voltage is VLM=N*Vout, N is the ratio of transformer T1, and Vout is the output voltage. When the AHB operates at rated maximum power, after the first switching transistor Q1 turns off, during freewheeling through the body diode of the second switching transistor Q2, the resonant capacitor voltage stored in the resonant capacitor Cr is Vcr_nom=N*Vnom, where Vnom is the rated maximum output voltage.

As an example, in step S702, the control chip obtains the rated turn-off current I_Mag_pos_nom of the first switching transistor Q1 and the preset rated turn-off current I_Mag_neg_nom of the second switching transistor Q2. Then, during the turn-on period of the first switching transistor Q1, the current change across the transformer magnetizing inductor LM is the difference between the rated turn-off current I_Mag_pos_nom of the first switching transistor Q1 and the preset rated turn-off current I_Mag_neg_nom of the second switching transistor Q2, i.e., I_Mag_pos_nom−I_Mag_neg_nom.

As an example, in step S703, due to the resonant capacitor voltage being

$$Vcr = N * Nout = LM * \frac{dI}{dt} = LM * \frac{( IMAGpos - IMAGneg )}{tLS\_on} ,$$

where IMAGpos is the positive peak current of the first switching transistor Q1 and IMAGneg is the negative current peak, the first turn-on time of the second switching transistor Q2 at rated maximum power is

$$toff\_om = LM * \frac{( I\_Mag \_pos \_nom - I\_Mag \_neg \_nom )}{N * Vnom} .$$

The control chip, based on the transformer T1 inductance LM of the asymmetric half-bridge circuit, the current change at rated maximum power I_Mag_pos_nom−I_Mag_neg_nom, and the resonant capacitor voltage Vcr_nom=N*Vnom, can calculate the rated turn-on time toff_nom of the second switching transistor Q2 at rated maximum power according to the formula

$$toff\_om = LM * \frac{( I\_Mag \_pos \_nom - I\_Mag \_neg \_nom )}{N * Vnom} .$$

In one embodiment, in step S502, acquiring the current conduction time of the second switching transistor based on the rated turn-off current of the first switching transistor, the rated conduction time of the second switching transistor, the current output voltage, and the current turn-off current of the first switching transistor includes:
substituting the rated turn-off current I_Mag_pos_nom of the first switching transistor, the rated conduction time toff_nom of the second switching transistor, the current output voltage Vout_DCM, and the current turn-off current I_Mag_pos_DCM of the first switching transistor into formula

$$toff\_DCM = \frac{K * toff\_nom * Vnom * I\_Mag \_pos \_DCM}{Vout\_DCM * I\_Mag \_pos \_nom}$$

to obtain the current conduction time toff_DCM of the second switching transistor, wherein K is a correction coefficient.

As an embodiment, according to the voltage regulation principle of the asymmetric half-bridge circuit, resonant capacitor voltage Vcr≈transformer magnetizing inductor voltage VLM. The transformer magnetizing inductor voltage is VLM=N*Vout, N is the ratio of transformer T1, Vout is the output voltage, and the resonant capacitor voltage is

$$Vcr = LM * \frac{dI}{dt} = LM * \frac{( IMAGpos - IMAGneg )}{tLS\_on} .$$

Here, LM is the inductance of transformer T1, IMAGpos is the peak value of the positive operating current of the first switching transistor Q1, IMAGneg is the peak value of the negative current, and tLS_on is the conduction time of the second switching transistor Q2. Therefore, when the asymmetric half-bridge circuit operates at the maximum power level, the resonant capacitor voltage satisfies the following equation:

$$Vcr = N * Vnom = LM * \frac{( I\_Mag \_pos \_nom - I\_Mag \_neg \_nom )}{toff\_nom} , \qquad ( Equation 1 ) ,$$

where Vnom is the output voltage at the maximum power level.

When the asymmetric half-bridge circuit operates under light-load conditions and enters DCM mode, the resonant capacitor voltage satisfies the following equation:

$$Vcr\_DCM = N * Vout\_DCM = LM * \frac{( I\_Mag \_pos \_DCM - I\_Mag \_neg \_DCM )}{toff\_DCM} , \qquad ( Equation 2 ) ,$$

where Vout_DCM is the current output voltage of the asymmetric half-bridge circuit in DCM mode.

Based on the equality of the inductance LM of the asymmetric half-bridge circuit at maximum power level and in DCM mode, combining Equation 1 and Equation 2 gives:

$$\frac{toff\_DCM * Vout\_DCM}{( I\_Mag \_pos \_DCM - I\_Mag \_neg \_DCM )} = \frac{toff\_nom * Vnom}{( I\_Mag \_pos \_nom - I\_Mag \_neg \_nom )} , \qquad ( Equation 3 ) .$$

It can be concluded that toff_DCM is inversely proportional to the current output voltage Vout_DCM and directly proportional to the current turn-off current I_Mag_pos_DCM of the first switching transistor.

During the operation of the asymmetric half-bridge circuit, the average current input to the asymmetric half-bridge circuit is

$$Iavg = \frac{1}{2} ( IMAGpos + IMAGneg ) * D ,$$

where IMAGpos represents the positive operating current peak value of the first switching transistor Q1, IMAGneg represents the negative current peak value. The input power is Pin=Vin*Iavg, and the output power is Pout=Vout*Iout. According to the principle of energy conservation between input and output: Pin≈Pout, and the relationship between the input voltage and the output voltage:

$$Vout = \frac{Vin * D}{N} ,$$

one obtains:

$$Iout = \frac{N}{2} ( IMAGpos + IMAGneg ) .$$

Therefore, based on the formula

$$Iout = \frac{N}{2} ( IMAGpos + IMAGneg ) ,$$

I_Mag_neg_DCMin Equation 3 can be expressed using Iout_DCM and IMag_pos_DCM. Eventually, I_Mag_pos_DCM−I_Mag_neg_DCM in Equation 3 is approximated by IMag_pos_DCM, andI_Mag_pos_nom−I_Mag_neg_nom in Equation 3 is approximated by IMag_pos_nom.

To eliminate the error caused by the approximation, the approximated Equation 3 can be multiplied by a correction factor K, where the value of K can be 1.1-1.7, to obtain:

$$\frac{toff\_DCM * Vout\_DCM}{I\_Mag \_pos \_DCM} = K * \frac{toff\_nom * Vnom}{I\_Mag \_pos \_nom} ; \qquad ( Equation 4 ) ;$$

$$Simplifying gives toff\_DCM = \frac{K * toff\_nom * Vnom * I\_Mag \_pos \_DCM}{Vout\_DCM * I\_Mag \_pos \_nom} ,$$

The control chip substitutes the current output voltage Vout_DCM, the current turn-off current I_Mag_pos_DCM of first switching transistor Q1, the rated on-time toff_nom of second switching transistor Q2, and the rated turn-off current I_Mag_pos_nom of first switching transistor Q1 into Equation 4 to calculate the current on-time toff_DCM of second switching transistor Q2.

In an embodiment, when the current turn-off current I_Mag_pos_DCM of the first switching transistor Q1 is within a first preset range, the correction factor K takes a first correction value; when I_Mag_pos_DCM is within a second preset range, K takes a second correction value.

Here, the first and second preset ranges correspond to the proportion of I_Mag_pos_DCM to the rated turn-off current I_Mag_pos_nom when the asymmetric half-bridge circuit operates in DCM mode. For example, when I_Mag_pos_DCM is within the first preset range, I_Mag_pos_DCM is 50%-70% of I_Mag_pos_nom; when I_Mag_pos_DCM is within the second preset range, I_Mag_pos_DCM is 30%-50% of I_Mag_pos_nom.

As an example, in practical applications of the asymmetric half-bridge circuit, the value of the correction factor K is related to the ratio of the current turn-off current I_Mag_pos_DCM of the first switching transistor Q1 to its rated turn-off current I_Mag_pos_nom. When calculating toff_DCM, since the approximations in equation 3 use I_Mag_pos_DCM for I_Mag_pos_DCM−I_Mag_neg_DCM, and I_Mag_pos_nom for I_Mag_pos_nom−I_Mag_neg_nom, a low ratio of I_Mag_pos_DCM to I_Mag_pos_nom, for example, I_Mag_pos_DCM being 30% of I_Mag_pos_nom, can result in a significant error. If K is set too low, for instance 1.1, it may not provide sufficient correction. Therefore, when I_Mag_pos_DCM is within a first preset range, for example 50%-70% of I_Mag_pos_nom, the correction factor K takes a first correction value, such as 1.1. In this case, because I_Mag_pos_DCM accounts for a relatively high proportion of I_Mag_pos_nom, a small correction value for K is sufficient. When I_Mag_pos_DCM is within a second preset range, for example 30%-50% of I_Mag_pos_nom, K takes a second correction value, such as 1.7. In this case, because I_Mag_pos_DCM accounts for a lower proportion of I_Mag_pos_nom, a larger correction value for K is needed to achieve the desired correction.

An embodiment of the present application also provides a control chip, including a memory, a processor, and a computer program stored in the memory and executable on the processor. The control chip can be used as control chip U1 in the asymmetric half-bridge circuit. When the processor of the control chip executes the computer program, it implements the control method for an asymmetric half-bridge circuit according to the above embodiments, for example, steps S401-S404 shown in FIG. 4. To avoid repetition, details are not described herein.

An embodiment of the present application also provides a power supply circuit, including a bridge rectifier with PFC circuit, an electrolytic capacitor C2, an asymmetric half-bridge circuit, a secondary rectifier-filter circuit, a protocol control module, and the control chip according to the above embodiments. The input of the bridge rectifier with PFC circuit is configured to be connected to the AC mains, and the output of the bridge rectifier with PFC circuit is connected to the electrolytic capacitor C2. The input of the asymmetric half-bridge circuit is connected to the electrolytic capacitor C2, and the output of the asymmetric half-bridge circuit is connected to the input of the secondary rectifier-filter circuit. The output of the secondary rectifier-filter circuit is configured to be connected to an external load to supply power to the external load. The control chip is connected to the first switching transistor Q1 and the second switching transistor Q2 in the asymmetric half-bridge circuit and is configured to, when the first detection data of the asymmetric half-bridge circuit meets a preset light-load condition, control the second switching transistor Q2 to conduct within the current conduction time toff_DCM, so that the current turn-off of the second switching transistor Q2, I_Mag_neg_DCM, is within a preset range. The protocol control module is connected to the output of the secondary rectifier-filter circuit, the asymmetric half-bridge circuit, and the control chip, and is configured to output a voltage adjustment signal to the control chip according to the power supply demand of the external load, so that the control chip adjusts the supply voltage output by the asymmetric half-bridge circuit according to the voltage adjustment signal.

As an example, the power supply circuit includes a bridge rectifier with PFC circuit, an electrolytic capacitor C2, an asymmetric half-bridge circuit, a secondary rectifier-filter circuit, a protocol control module, and the control chip of the above example. The input of the bridge rectifier with PFC circuit is configured to be connected to the AC mains, and the output of the bridge rectifier with PFC circuit is connected to the electrolytic capacitor C2. The input of the asymmetric half-bridge circuit is connected to the electrolytic capacitor C2 to receive an input voltage Vin, and the output of the asymmetric half-bridge circuit is connected to the input of the secondary rectifier-filter circuit. The output of the secondary rectifier-filter circuit is configured to be connected to an external load to supply power to the external load, and the secondary rectifier-filter circuit is further configured to passively adjust the output current Iout according to the resistance at the connected external load interface in response to the charging demand of the external load. The control chip is connected to the first switching transistor Q1 and the second switching transistor Q2 in the asymmetric half-bridge circuit and is configured to, when the first detection data of the asymmetric half-bridge circuit meets a preset light-load condition, control the second switching transistor Q2 to conduct within the current conduction time toff_DCM, so that the current turn-off of the second switching transistor Q2, I_Mag_neg_DCM, is within a preset range. The protocol control module is connected to the output of the secondary rectifier-filter circuit, the asymmetric half-bridge circuit, and the control chip, and is configured to output a voltage adjustment signal to the control chip according to the power supply demand of the external load, so that the control chip adjusts the output supply voltage Vout of the asymmetric half-bridge circuit according to the voltage adjustment signal.

In this example, the control chip in the power supply circuit is capable of obtaining the current conduction time toff_DCM of the second switching transistor Q2 based on the current output voltage Vout_DCM, the current turn-off current I_Mag_pos_DCM of the first switching transistor Q1, the rated conduction time toff_nom of the second switching transistor Q2, and the rated turn-off current I_Mag_pos_nom of the first switching transistor Q1. The current conduction time toff_DCM of the second switching transistor Q2 is inversely proportional to the current output voltage Vout and directly proportional to the current turn-off current I_Mag_pos_DCM of the first switching transistor Q1. This arrangement can compensate for variations in the demagnetization time of the magnetizing inductor caused by changes in the output voltage of the asymmetric half-bridge circuit, ensuring that the negative current after transformer T1 demagnetization remains within a preset range, and meeting the ZVS requirement of the first switching transistor Q1 when the asymmetric half-bridge circuit operates in DCM mode.

The embodiments of the present application further provide a charger, which includes the power supply circuit of the above embodiments.

As an example, the charger includes the power supply circuit described above. In this example, the control chip in the power supply circuit is capable of obtaining the current conduction time toff_DCM of the second switching transistor Q2 based on the current output voltage Vout_DCM, the current turn-off current I_Mag_pos_DCM of the first switching transistor Q1, the rated conduction time toff_nom of the second switching transistor Q2, and the rated turn-off current I_Mag_pos_nom of the first switching transistor Q1. The current conduction time toff_DCM of the second switching transistor Q2 is inversely proportional to the current output voltage Vout and directly proportional to the current turn-off current I_Mag_pos_DCM of the first switching transistor Q1. This configuration compensates for variations in the demagnetization time of the magnetizing inductor caused by changes in the output voltage of the asymmetric half-bridge circuit, ensures that the negative current after transformer T1 demagnetization remains within a preset range, and satisfies the ZVS requirement of the first switching transistor Q1 when the asymmetric half-bridge circuit operates in DCM mode.

The above embodiments are merely used to illustrate the technical solutions of the present application, rather than limit it. Although the application has been described in detail with reference to the foregoing embodiments, it should be understood by those skilled in the art that it is still possible to modify the technical solutions described in the foregoing embodiments, or equivalently replace some technical features thereof. These modifications and equivalents do not make the nature of the corresponding technical solution deviates from the spirit and scope of the present application, and shall be included in the protection scope of the present application.

What is claimed is:

1. A control method for an asymmetric half-bridge circuit, wherein the asymmetric half-bridge circuit comprises a transformer, a first switching transistor, a second switching transistor, a resonant inductor, and a resonant capacitor; the first switching transistor has a first end configured to be connected to a bridge rectifier and a PFC circuit, a second end configured to be connected to a control chip, and a third end connected to a first end of the second switching transistor; the second switching transistor has a second end configured to be connected to the control chip, and a third end connected to ground; the resonant inductor, the resonant capacitor, and a primary winding of the transformer are connected in series between the third end of the first switching transistor and the third end of the second switching transistor; wherein the control method comprises:
acquiring first detection data of the asymmetric half-bridge circuit;
when the first detection data satisfies a preset light-load condition, turning off the first switching transistor and acquiring a current output voltage and a current turn-off current of the first switching transistor;
acquiring a current conduction time of the second switching transistor based on the current output voltage and the current turn-off current of the first switching transistor, wherein the current conduction time is proportional to the current turn-off current and inversely proportional to the current output voltage; and
controlling the second switching transistor to conduct during the current conduction time, so that when the second switching transistor turns off, the current turn-off current of the second switching transistor is within a preset range.

2. The control method for an asymmetric half-bridge circuit of claim 1, wherein the first detection data comprises a current output current; and
the preset light-load condition is that the current output current is less than a preset current.

3. The control method for an asymmetric half-bridge circuit of claim 1, wherein acquiring a current conduction time of the second switching transistor based on the current output voltage and the current turn-off current of the first switching transistor comprises:
acquiring a rated turn-off current of the first switching transistor and a rated conduction time of the second switching transistor at rated maximum power; and
acquiring the current conduction time of the second switching transistor based on the rated turn-off current of the first switching transistor, the rated conduction time of the second switching transistor, the current output voltage, and the current turn-off current of the first switching transistor.

4. The control method for an asymmetric half-bridge circuit of claim 3, wherein acquiring a rated turn-off current of the first switching transistor at rated maximum power comprises:
acquiring a target turn-off current at rated maximum power based on the output current at the rated maximum power and a transformer ratio of the asymmetric half-bridge circuit, wherein the target turn-off current is the sum of the rated turn-off current of the second switching transistor and the rated turn-off current of the first switching transistor; and
acquiring the rated turn-off current of the first switching transistor at the rated maximum power based on the rated turn-off current of the second switching transistor and the target turn-off current.

5. The control method for an asymmetric half-bridge circuit of claim 3, wherein acquiring a rated conduction time of the second switching transistor at rated maximum power comprises:
acquiring, based on an output voltage at the rated maximum power and a transformation ratio of the asymmetric half-bridge circuit, a resonant capacitor voltage stored in the resonant capacitor when current continues flowing through a body diode of the second switching transistor after the first switching transistor is turned off;
acquiring, based on the rated turn-off current of the first switching transistor and a preset rated turn-off current of the second switching transistor, a current variation at the rated maximum power; and
acquiring, based on an inductance of the transformer of the asymmetric half-bridge circuit, the current variation at the rated maximum power, and the resonant capacitor voltage, the rated conduction time of the second switching transistor at the rated maximum power.

6. The control method for an asymmetric half-bridge circuit of claim 3, wherein acquiring the current conduction time of the second switching transistor based on the rated turn-off current of the first switching transistor, the rated conduction time of the second switching transistor, the current output voltage, and the current turn-off current of the first switching transistor comprises:
substituting the rated turn-off current of the first switching transistor, the rated conduction time of the second switching transistor, the current output voltage, and the current turn-off current of the first switching transistor into formula
$$toff\_DCM = \frac{K * toff\_nom * Vnom * I\_Mag \_pos \_DCM}{Vout\_DCM * I\_Mag \_pos \_nom}$$
to obtain the current conduction time of the second switching transistor, wherein K is a correction coefficient, toff_nom is the rated conduction time of the second switching transistor, Vnom is the output voltage of the asymmetric half-bridge circuit at the maximum power level, I_Mag_pos_DCM is the current turn-off current of the first switching transistor, Vout_DCM is the current output voltage, and I_Mag_pos_nom is the rated turn-off current of the first switching transistor.

7. The control method for an asymmetric half-bridge circuit of claim 6, wherein when the current turn-off current of the first switching transistor is within a first preset range, the correction coefficient K takes a first correction value; and
when the current turn-off current of the first switching transistor is within a second preset range, the correction coefficient K takes a second correction value.

8. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 1 is implemented.

9. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 2 is implemented.

10. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 3 is implemented.

11. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 4 is implemented.

12. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 5 is implemented.

13. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 6 is implemented.

14. A control chip, comprising a memory, a processor, and a computer program stored in the memory and executable on the processor, wherein the control chip is applied in an asymmetric half-bridge circuit, and when the processor executes the computer program, the control method for an asymmetric half-bridge circuit of claim 7 is implemented.

15. A power supply circuit, comprising a bridge rectifier with PFC circuit, an electrolytic capacitor, an asymmetric half-bridge circuit, a secondary rectifier-filter circuit, a protocol control module, and the control chip of claim 8; wherein
an input terminal of the bridge rectifier with PFC circuit is configured to be connected to a mains circuit, and an output terminal of the bridge rectifier with PFC circuit is connected to the electrolytic capacitor;
an input terminal of the asymmetric half-bridge circuit is connected to the electrolytic capacitor, and an output terminal of the asymmetric half-bridge circuit is connected to an input terminal of the secondary rectifier-filter circuit;
an output terminal of the secondary rectifier-filter circuit is configured to be connected to an external load to supply power to the external load;
the control chip is connected to the first switching transistor and the second switching transistor in the asymmetric half-bridge circuit; and the control chip is configured to, when the first detection data of the asymmetric half-bridge circuit satisfies the preset light-load condition, control the second switching transistor to conduct during the current conduction time, so that the current turn-off current of the second switching transistor is within the preset range;
the protocol control module is connected to the output terminal of the secondary rectifier-filter circuit, the asymmetric half-bridge circuit, and the control chip; and the protocol control module is configured to, based on a power demand of the external load, output a voltage adjustment signal to the control chip, so that the control chip adjusts the magnitude of a supply voltage output by the asymmetric half-bridge circuit according to the voltage adjustment signal.

16. A charger, comprising the power supply circuit of claim 15.
